(19) United States
(12) Patent Application Publication
(10) Pub. No.: US 2006/0224424 A1
(43) Pub. Date: Oct. 5, 2006

(54) Business context services for adaptable service oriented architecture components

(75) Inventors: Darshanand Khusial, Mississauga (CA); Victor Chan, Thornhill (CA); Mark William Hubbard, Maple (CA)

Correspondence Address: International Business Machines;Intellectual Property Law T81/503, 3039 Cornwallis Road, P.O. Box 12195, T-8/503, Research Triangle Park, NC, 27709, US

(73) Assignee: INTERNATIONAL BUSINESS MACHINES CORPORATION, ARMONK, NY (US)

(21) Appl. No.: 11/098,994

(22) Filed: Apr. 5, 2005

(51) Int. Cl. G06F 9/44

(52) U.S. Cl. 705/7

(57) ABSTRACT

A method, system and apparatus for a commerce system having a service oriented architecture (SOA). The SOA commerce system of the present invention can include a component logic container exposing an interface to one or more accessing clients and having a configuration for hosting one or more business components. The SOA commerce system also can include a business context engine disposed with the container and exposing an interface to the accessing clients. Finally, the SOA commerce system can include a business component facade disposed within the container and having a configuration for both invoking selected ones of the business components and for communicating with the business context engine.

### BACKGROUND OF THE INVENTION

The present invention relates to the field of commerce computing and more particularly to component based commerce systems.

As businesses and consumers become further interconnected through computer communications networks such as the global Internet and local intranets, the commerce sites and companion computing applications which integrate interactions between businesses and consumers alike can become ever more complex. Addressing the explosion of business to business and business to consumer interactions on-line, information technologists increasingly focus on architecting and implementing complete commerce site solutions to reflect the entire life cycle of a business in lieu of integrating multiple, disparate applications which when combined reflect the business life cycle. Consequently, as modem commerce sites can be both large and distributed, commerce systems have been configured to deploy complete e-commerce systems in as seamless a fashion as possible.

It is now a common trend that traditional, stand-alone, commerce oriented applications are produced from one or more components which can be individually re-used to create business processes for different solutions. Each of these components can expose itself as a set of services comporting with computing standards for deploying enterprise level logic that facilitate an open service oriented architecture (SOA). An SOA essentially can be defined as a collection of services. These services communicate with each other, which communication can involve either simple data passing between two or more services, activity coordinating by two or more services.

In a SOA, a client can invoke a service within a component to perform an operation and, optionally the client can receive a response. Invoked services generally can include business services configured to fulfill the needs of business customers, whether those customers are individual consumers or other businesses. The services can be grouped into various SOA components where each component can specialize in functions such as catalog management, shopping car management, credit card transaction processing, sales tax computation and the like.

By utilizing an SOA, components in a commerce solution can interoperate with other business processes in a larger commerce solution involving one or more separate business entities and one or more separate consumer entities.

Within a traditional commerce platform product, a commerce model represents a commerce solution such as a consumer-direct commerce model, a business-direct commerce model, a supply chain commerce model and demand-chain commerce model to name only a few commerce models. Commerce models can be assembled from a set of common components to achieve the desired affect represented by the commerce model. As such, with a high demand placed upon component re-use, a method to adapt components into a commerce model can avoid having to customize the component for each solution.

Within a commerce model, stateless transactions can be combined to form an activity in the aggregate. The context of the activity can be maintained centrally by the commands forming the basis of the commerce system implementing the commerce model. The context can include aspects of an activity such as the parties to the activity, the resources supporting the completion of the activity, and the medium of the activity. For example, contextual data can include a store identifier, a common language identifier, or a currency type.

The use of centralized context management requires the proprietary management of contextual data outside of the scope of the components defining the commerce model. In this regard, session management can be used to persist an activity across multiple requests such that the context of the activity associated with the requestor need not be re-established on every request. Communicating with the session management portion of the commerce system, however, can require knowledge of the interface of the session management portion and can inhibit the realization of an SOA architected commerce system.

### BRIEF SUMMARY OF THE INVENTION

According to one aspect of the present invention, a SOA commerce system can include a component logic container exposing an interface to one or more accessing clients and having a configuration for hosting one or more business components. The SOA commerce system also can include a business context engine disposed within the container and exposing an interface to the accessing clients. Finally, the SOA commerce system can include a business component facade disposed within the container and having a configuration for both invoking selected ones of the business components and for communicating with the business context engine.

According to another aspect of the present invention, a method for adapting commerce system components in a SOA through business contexts can include assigning an activity token to at least one context for the activity in response to receiving a request to begin an activity from a requestor. The method further can include returning the activity token to the requestor. Finally, the method can include, responsive to a request to complete the activity by the requestor, destroying the activity token.

According to yet another aspect of he present invention, a computer program product for adapting commerce system components in a service oriented architecture (SOA) through business contexts comprises a computer readable medium having computer readable program code embodied therein. The computer readable program code comprises computer readable program code configured to assign an activity token to at least one context for said activity in response to receiving a request to begin an activity from a requestor, computer readable program code configured to return said activity token to said requestor; and computer readable program code configured to destroy said activity token in response to a request to complete said activity by said requestor.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a schematic illustration of a commerce system configured to manage business context services for adaptable SOA components;

FIG. 2 is a block diagram illustrating a process for utilizing the business context services of the commerce system of FIG. 1;

FIG. 3 is a block diagram illustrating a process for intra-component utilization of the business context services of the commerce system of FIG. 1;

FIG. 4 is an object diagram illustrating a business context services architecture; and,

FIGS. 5A and 5B, taken together, are an object diagram illustrating an architecture configured to permit varied access to the architecture of FIG. 4.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

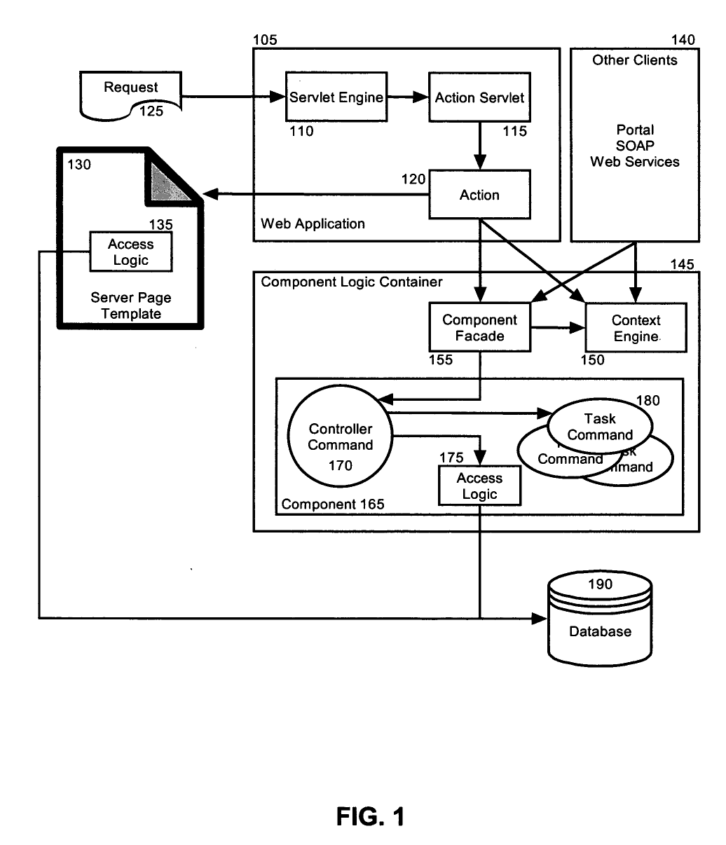

FIG. 1 is a schematic illustration of an exemplary albeit non-exclusive commerce system configured to manage business context services for adaptable SOA components. The commerce system can include one or more service invoking client platforms including a Web application 105, as well as other clients 140 such as a portal client, simple object access protocol (SOAP) client, and a Web services client to name a few. For purposes of illustrative efficiency, only a Web application 105 is shown in detail.

The Web application 105 communicatively coupled to a component logic container 145 which in turn can be communicatively coupled to persistent storage 190. The Web application 105 can host a servlet engine 110 which can process requests 125 for commerce services through an action servlet 115. The action servlet 115, in turn, can be configured to invoke actions 120 logically linked both to a commerce application view 130 and also to a component facade 155 programmed to invoke business logic within one or more components 165 disposed with the component logic container 145.

For instance, the component facade 155 can be a component stateless session bean (SSB) logically coupled to one or more components 165 which when combined form a commerce system solution. Each of the components 165 can include a controller command 170 having one or more task commands 180. The controller command 170 further can be logically linked to access logic 175 configured to access persisted data in the database 190. Similarly, the commerce application view 130 can include access logic 135 likewise configured to access persisted data in the database 190.

Notably, the component facade 155 can be coupled to a business context engine 150. The business context engine 150 can manage an activity, where the activity can include a series of consecutive requests 125 from one or more service clients, in order to treat the consecutive series of requests 125 as a single conversation as between the service clients and the commerce system service defined by the components 165. The context engine 150 is responsible for managing the business contexts associated with an activity.

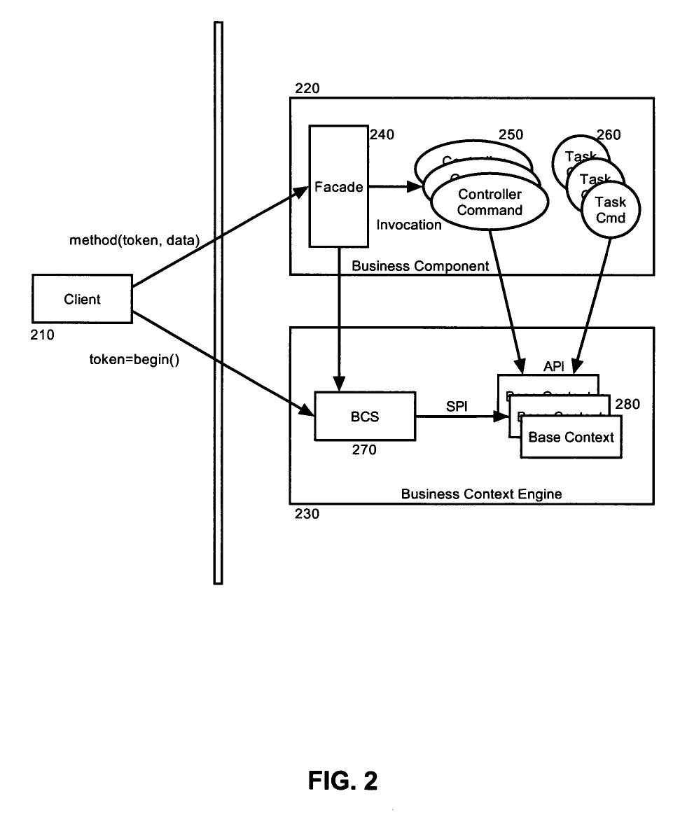

As it will be apparent from the schematic illustration of FIG. 1, the SOA of FIG. 1 can be divided into two main parts: the context engine and the component service. The context engine provides context related services while the component service provides a facade to the commands and facilities to instantiate and execute a command in the commerce system. FIG. 2 is a block diagram illustrating a process for utilizing the business context services of the commerce system of FIG. 1 in the course of executing the business logic of a system component.

As shown in FIG. 2, a client computing process 210 can establish a communicative linkage to a business component 220 in addition to a business context engine 230. The business component 220 can include a component facade 240 through which business logic in the form of controller commands 250 and underlying task commands 260 can be invoked. The business context engine 230, in turn, can include a business context service 270 coupled to one or more business contexts 280.

In operation, the client computing process 210 can obtain an activity token from the business context engine 230 which can include a specific set of business contexts. The client computing process 210 subsequently can pass the activity token to the business component 220 in the course of a business task in order to provide contextual information for completing the task. For instance, the business component 220 further can access elements of the business contexts 280 by way of an application programming interface (API) to the business context engine 230 utilizing the specific information of the activity token.

Specifically, to invoke a method on a business component, a client 210 or component facade 240 can obtain an activity token by first making a call to the interface of the business context service 270. In the process of obtaining the activity token, the client 210 or component facade 240 optionally can supply initialization data that can be used to populate pre-loaded contexts during creation of a new activity. Subsequently, the client 210 can pass the activity token to the component facade 240 when a particular method is invoked on the interface to the business component 220.

Notably, the activity token can be used to associate a set of contexts in effect during particular client requests to the various business components. The client can supply the activity token on every request to indicate the experience that the client would like from the business components. These contexts can include, by way of example, a solutions context indicating whether a requested operation in an activity is to be performed by a specified entity, or through an entity which acts on behalf of a specified entity. The contexts also can include a globalization context providing globalization information, an entitlement context providing information for promotional entitlement programs, a content context providing versioning information for specified content, a task context indicating a current task or state for an process having multiple tasks, and an audit context providing auditing information, to name only a few contexts.

The context of a business task can be maintained across one or more business contexts which can be incorporated into or referenced by activity tokens passed between the different business components when processing the task. Consequently, the state of each business context can be maintained across requests and transactions so that a significant performance improvement can be realized.

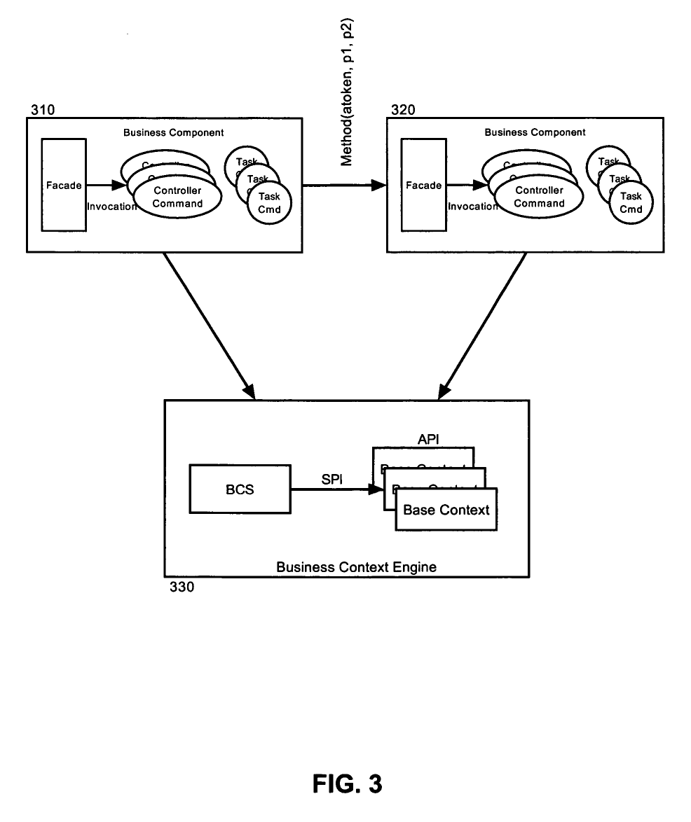

Notably, multiple business components can operate within the same process address space such as the same virtual machine. In this circumstance, each of the components can share the same business context engine. Accordingly, the passing of an activity token containing or referencing the context for an activity can occur directly as between the components in the course of an intra-component call. Specifically, FIG. 3 is a block diagram illustrating a process for intra-component utilization of the business context services of the commerce system of FIG. 1. As shown in FIG. 3, two business components 310, 320 residing within the same process address space can share the business context engine 330. Consequently, to pass the context of an activity between the components in the course of an intra-component call, the token produced by the business context engine 330 can be passed directly between the business components 310, 320.

As shown in both FIGS. 2 and 3, the business context engine can be logically partitioned into a business context service and one or more business contexts. The business context service can include a service where one associates multiple unique contexts used by various components under a single identifier for a limited lifetime—the activity itself. The lifetime of an activity can span multiple requests and transactions. More specifically, the business context service is the facility that a solution controller responsible for managing the activity on behalf of the client can use to manage the set of contexts needed by the business components. The business context service also can serve as the interface which the components use to obtain the various contexts required by the components.

The business contexts in turn provide the data and services required by the components. Specifically, business contexts can have the following characteristics:

A context can establish an execution environment that affects the output of a business component for equivalent input based upon the solution requirements.

The output produced by a business component for a given input can be identical for the same set of contexts.

Contexts need not be directly invoked by clients of the business processes. Instead the business component can use the services provided by the contexts during the execution of a request.

A context provides a set of service methods and optionally can provide data.

The lifespan of a context starts with the creation of an activity and ends with the completion of the activity.

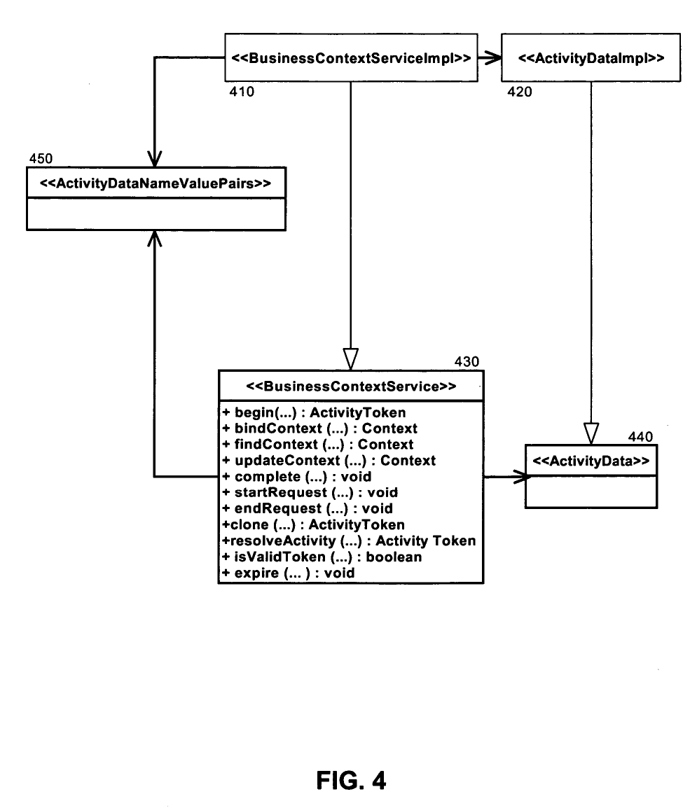

In further illustration, FIG. 4 is an object diagram illustrating an exemplary business context services architecture. The architecture can include a Business Context Service Implementation class 410 implementing a Business Context Service interface 430. The Business Context Service Implementation class 410 can include a reference to at least one Activity Data Implementation class 420 which can implement the Activity Data interface 440. Finally, the Business Context Service Implementation class 410 can include a reference to at least one Activity Data Name Value Pairs class 450.

The Business Context Service interface 430 can define a number of method members for creating and managing contexts for an activity, including one or more methods for invoking the business context service at the beginning of an activity. For instance, responsive to the invocation of the business context service for a new activity having specified activity data, an activity can be created utilizing the specified activity data. Also, an activity can be created utilizing specified activity data name value pairs. A new activity yet further can be created based upon a clone of an existing activity. Finally, an existing activity can have a new context bound to the activity in order to support dynamic context creation.

Generally, a business context class (not shown) configured for use in the business context services architecture of the present invention can implement two interfaces. The first interface can be an API interface which business components can use to interact with a business context instance and to retrieve or populate context information using data provided by a business context instance. The second interface can be a service provider interface (SPI) used by the business context service to create a business context instance and to indicate to the business context instance when the business context instance is to populate its data members with initialization data, when the business context instance is to persist its data members, when the business context instance is to reload its data members form a persistent media, and when the business context instance is to clone itself.

As an example, the APIs of the Business Context Service can include:

begin( . . . )—The component facade can call the begin( . . . ) method to obtain a new activity. The activity can be associated with new business context instances defined in a configuration file.

complete( . . . )—The component facade can call the complete ( . . . ) method to terminate an activity and destroy its associated set of business context instances.

clone( . . . )—The component facade can create a new activity by replicating the information stored in an existing business context instance.

The SPIs, of the Business Context Service by comparison, can include:

startRequest( . . . )—A business component can call the startRequest( . . . ) method before performing any context related operations for a request or transaction associated with an activity. Consequently, the business context service can perform any necessary pre-processing related to the contexts associated with the activity.

endRequest( . . . )—A business component can call the endRequest( . . . ) method after performing all context related operations for the current request or transaction associated with an activity. Consequently, the business context service can perform any necessary post-processing related to the contexts associated with the activity.

bindContext( . . . )—The bindContext( . . . ) method permits a business component to dynamically associate a new context with an activity.

findContext( . . . )—The findContext( . . . ) method permits a business component to retrieve context information associated with an activity.

updateContext( . . . )—The updateContext( . . . ) method permits a business component to update a context.

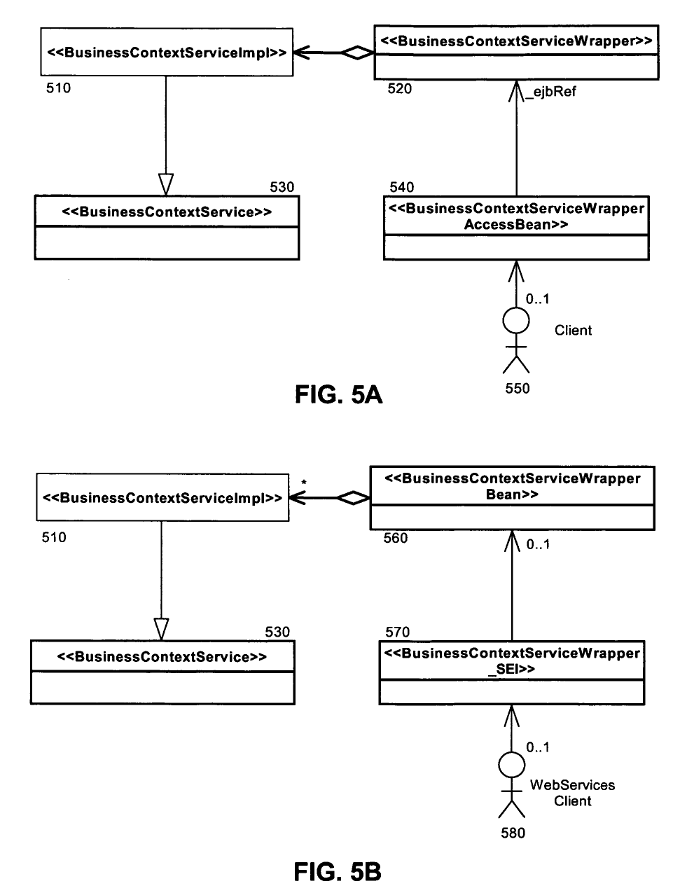

The Business Context Service Implementation class 410 can be accessed in many ways, including through a stateless session bean and through a Web services wrapper. FIGS. 5A and 5B, taken together, is an object diagram illustrating an architecture configured to permit varied access to the business context services architecture of FIG. 4. Specifically, in FIG. 5A, the Business Context Service Implementation 510 implementing the Business Context Service Interface 530 can be accessed indirectly through a Web services wrapper 520 via an access bean 540. Alternatively, as shown in FIG. 5B, the Business Context Service Implementation 510 can be accessed indirectly through a service wrapper bean 560 by way of a stateless session bean 570 for the wrapper 560.

The flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is apparent to one skilled in the art that numerous modifications and departures from the specific embodiments described herein may be made without departing from the spirit and scope of the invention.

We claim:

1. A commerce system having a service oriented architecture (SOA), the commerce system comprising:
a component logic container exposing an interface to a plurality of accessing clients and having a configuration for hosting a plurality of business components;
a business context engine disposed with said container and exposing an interface to said accessing clients; and,
a business component facade disposed within said container and having a configuration for both invoking selected ones of said business components and for communicating with said business context engine.

2. The commerce system of claim 1, wherein said business context engine comprises:
a business context service; and,
a plurality of business contexts accessible by said business context service.

3. The commerce system of claim 1, wherein said accessing clients comprise an application server hosted servlet.

4. The commerce system of claim 1, wherein said accessing clients comprise a Web services client.

5. The commerce system of claim 1, wherein each of said business components comprises a controller command coupled to at least one task command, and access logic configured to retrieve data from persistent storage.

6. The commerce system of claim 2, wherein said component facade comprises a stateless session bean configured for communicative coupling both to said business components and also to said business context service.

7. The commerce system of claim 1, wherein said business context service is an instance of a business context service implementation class which implements a business context service interface, said business context service interface comprising a plurality of methods, said methods defining an application programming interface (API) for use by said business components and a service provider interface (SPI) for use by said business context service in managing business contexts for an activity.

8. The commerce system of claim 7, further comprising an instance of a business context service wrapper configured to permit access to said instance of said business context service implementation class by a business context service access bean.

9. The commerce system of claim 7, further comprising a business context service wrapper bean configured to permit access to said instance of said business context service implementation class by a business context service wrapper instance.

10. A method for adapting commerce system components in a service oriented architecture (SOA) through business contexts, the method comprising:
assigning an activity token to at least one context for said activity in response to receiving a request to begin an activity from a requestor;
returning said activity token to said requestor; and
destroying said activity token in response to a request to complete said activity by said requestor.

11. The method of claim 10, further comprising passing said activity token to each business component associated with said activity when requesting services from each said business component in order to establish a context for said services.

12. The method of claim 10, wherein assigning an activity token to at least one context for said activity in response to receiving a request to begin an activity from a requestor comprises creating a new context for said activity.

13. The method of claim 10, wherein assigning an activity token to at least one context for said activity in response to receiving a request to begin an activity from a requestor comprises binding an existing context to said activity.

14. The method of claim 10, wherein assigning an activity token to at least one context for said activity in response to receiving a request to begin an activity from a requestor comprises cloning an existing context for an existing activity to produce a new context.

15. The method of claim 10, further comprising:
pre-processing a request in said activity; and,
post-processing a request in said activity.

16. A computer program product for for adapting commerce system components in a service oriented architecture (SOA) through business contexts, the computer program product comprising:
a computer readable medium having computer readable program code embodied therein, the computer readable program code comprising:
computer readable program code configured to assign an activity token to at least one context for said activity in response to receiving a request to begin an activity from a requestor;
computer readable program code configured to return said activity token to said requestor; and
computer readable program code configured to destroy said activity token in response to a request to complete said activity by said requestor.

17. The computer program product of claim 16, further comprising computer readable program code configured to pass said activity token to each business component associated with said activity when requesting services from each said business component in order to establish a context for said services.

18. The computer program product of claim 16, wherein said computer readable program code configured to assign an activity token to at least one context for said activity in response to receiving a request to begin an activity from a requestor comprises computer readable program code configured to create a new context for said activity.

19. The computer program product of claim 16, wherein said computer readable program code configured to assign an activity token to at least one context for said activity in response to receiving a request to begin an activity from a requestor comprises computer readable program code configured to bind an existing context to said activity.

20. The computer program product of claim 16, wherein said computer readable program code configured to assign an activity token to at least one context for said activity in response to receiving a request to begin an activity from a requestor comprises computer readable program code configured to clone an existing context for an existing activity to produce a new context.

21. The computer program product of claim 16, further comprising computer readable program code configured to pre-process a request in said activity; and computer readable program code configured to post-process a request in said activity.
